(19) United States
(12) Patent Application Publication
(10) Pub. No.: US 2012/0134138 A1
(43) Pub. Date: May 31, 2012

(54) BACKLIGHT DEVICE AND DISPLAY DEVICE PROVIDED WITH BACKLIGHT DEVICE

(75) Inventor: Tamotsu Satoh, Osaka (JP)

(73) Assignee: SHARP KABUSHIKI KAISHA, Osaka (JP)

(21) Appl. No.: 13/388,432

(22) PCT Filed: Jun. 16, 2010
(86) PCT No.: PCT/JP2010/060233

§ 371 Date: Feb. 1, 2012

(30) Foreign Application Priority Data
Aug. 7, 2009 (JP) 2009-184826

(51) Int. Cl. G09F 13/14; G09F 13/04

(52) U.S. Cl. 362/97.1

(57) ABSTRACT

Provided is a display device in which a lamp can be replaced in a simple manner. In this display device 100, at least one lamp unit 40 having at least one lamp 52 and a base portion 42 provided with a lamp socket 48 to which the lamp 52 is attached and to which the lamp 52 is electrically connected is detachably mounted inside a chassis 30. In a portion of a wall 85 of a cabinet 80, a lamp unit insertion opening 86 through which the lamp unit 40 can be inserted or removed is formed. The lamp unit 40 is removed from the inside of the cabinet 80 to the outside of the cabinet 80, and is inserted from the outside of the cabinet 80 to the inside of the cabinet 80 through the lamp unit insertion opening 86.

### TECHNICAL FIELD

The present invention relates to a backlight device (illumination device) that is used as a light source for irradiating a display panel provided in a display device and to a display device provided with the backlight device. Specifically, the present invention relates to a backlight device provided with a detachable lamp unit and to a display device provided with the backlight device.

The present application claims priority to Patent Application No. 2009-184826 filed in Japan on Aug. 7, 2009. The entire contents of which are hereby incorporated by reference.

### BACKGROUND ART

In recent years, liquid crystal display devices, which are used as image display devices (displays), such as televisions, personal computers, and the like, are becoming larger. Along with such increase in their size, backlight devices (illumination devices), which are light sources for liquid crystal panels, are becoming larger as well. As liquid crystal panels become larger, the length of lamps having long (linear) shapes (fluorescent tubes, for example) that are used in direct type backlight devices, for example, is also increasing.

Such a direct type backlight device has a lamp clip (light source retainer) for supporting the above-mentioned long lamp. This lamp clip is disposed along the lengthwise direction of the lamp at prescribed intervals in a chassis (typically, on a bottom surface of the chassis) in which the lamp is stored. As a typical example of such a lamp clip, a lamp clip having the following configuration can be mentioned, for example. In this configuration, a sheet-shaped reflective member for reflecting light from the lamp to the side of a liquid crystal panel is disposed on a bottom surface of the chassis. The tip of the lamp clip is inserted and fitted into a through hole formed in the bottom surface of the chassis and an insertion hole formed in the reflective member at a location corresponding to the through hole such that the lamp clip is securely attached to the bottom surface of the chassis through the reflective member (i.e., the lamp clip holding down the reflective member onto the bottom surface of the chassis), thereby preventing the lamp clip from being detached.

Here, a liquid crystal display device (liquid crystal television, for example) that has, as a light source for a liquid crystal panel, a backlight device having a lamp clip of the above-mentioned configuration is typically built such that a set of members and parts constituting the liquid crystal display device (i.e., the device main unit), such as a liquid crystal panel, a backlight device, and the like, are stored in a case such as a cabinet or the like. When a lamp of the backlight device needs to be replaced while such a liquid crystal display device is in use, the device main unit needs to be removed from the cabinet. Then, the device main unit needs to be disassembled to remove the lamp from the lamp clip. Such replacement work is complex, and precision parts constituting the device main unit must be handled with the utmost care. Therefore, there has been little choice but to depend on a specialist to perform such replacement work.

As a measure for facilitating replacement of a lamp inside the above-mentioned display device, means described in Patent Documents 1 and 2 have been suggested, for example. Patent Document 1 describes a method in which an edge light type backlight device having a light guide plate is mounted inside a design case (corresponds to the above-mentioned case) separately from other parts so that only the lamp is removed without touching a liquid crystal panel to perform replacement. Patent Document 2 describes a method in which a light source and a power supply line in a direct type backlight device can be attached or removed in a simple manner in order to facilitate replacement of the light source.

### RELATED ART DOCUMENTS

### Patent Documents

Patent Document 1: Japanese Patent Application Laid-Open Publication No. H4-288526
Patent Document 2: Japanese Patent Application Laid-Open Publication No. 2005-302533

### SUMMARY OF THE INVENTION

### Problems to be Solved by the Invention

However, it is difficult to apply the technique described in Patent Document 1 to a liquid crystal display device such as a flat screen liquid crystal television, for example, in which a direct type backlight device is commonly used because the configuration inside the backlight device is different. Furthermore, when applying the technique described in Patent Document 2 to a large liquid crystal display device provided with a backlight device having a configuration in which a lamp is held by a lamp clip as described above, it is difficult to remove only the lamp, which is held by the lamp clip, along the lengthwise direction of the lamp. Moreover, it is also difficult to replace the lamp along with the lamp clip, which is secured to a backlight chassis through a reflective sheet.

Thus, the present invention seeks to address such issues, and its primary object is to provide a display device that allows a lamp to be replaced in a simple manner. Another object is to provide a backlight device that is used in such a display device.

### Means for Solving the Problems

In order to achieve above objects, a display device provided by the present invention has a backlight device having a lamp and a chassis in which the lamp is stored, a display panel illuminated by the backlight device, and a cabinet surrounding the backlight device and the display panel. In the display device, at least one lamp unit having at least one lamp and a base portion provided with a lamp socket to which the lamp is attached and to which the lamp is electrically connected is detachably mounted inside the chassis. Here, in a portion of a wall of the cabinet, a lamp unit insertion opening through which the lamp unit can be removed or inserted is formed so that the lamp unit is removed from an inside of the cabinet to an outside of the cabinet and that the lamp unit is inserted from the outside of the cabinet to the inside of the cabinet through the lamp unit insertion opening.

A display device according to the present invention has a lamp unit that is mounted inside a chassis and that, through a lamp unit insertion opening formed in a cabinet, can be removed from the cabinet and inserted to the cabinet. Therefore, the lamp unit having a lamp that needs to be replaced due to an end of service life or the like can be removed from the inside of the cabinet to the outside through the lamp unit insertion opening in a simple manner, and can be reinserted from the outside of the cabinet to the inside to be mounted. Therefore, according to the display device of the present invention, lamp replacement can be performed in a simple manner at the lamp unit level without disassembling the display device (without detaching the cabinet from the panel, for example).

In a preferred aspect of the display device disclosed here, the cabinet has a frame-shaped quadrilateral side wall portion formed so as to cover the chassis. The lamp unit insertion opening is formed in at least one side wall of a pair of side walls of the quadrilateral side wall portion facing each other. Here, at a bottom surface portion of the chassis that is adjacent to the lamp unit insertion opening, a guide portion that retains a portion of the base portion of the lamp unit inserted from the lamp unit insertion opening in a slidable manner is formed.

According to a display device having such a configuration, the base portion is slid along the guide portion such that the lamp unit can be removed from and inserted into the cabinet more smoothly. Therefore, even simpler lamp replacement can be achieved.

In a preferred aspect of the backlight device provided in the display device disclosed here, a reflective portion for reflecting light emitted from a lamp provided in the lamp unit is formed on at least a portion of a surface of the base portion of the lamp unit.

In a chassis of a backlight device in a conventional display device, a sheet-shaped reflective member for reflecting light emitted from a lamp is disposed (typically, spreading to cover substantially all of the surface of a bottom surface of the chassis). Here, in a backlight device (display device) having a configuration provided with a lamp unit that is detachably mounted on a chassis as described above, it is difficult to dispose the reflective member in a region where the lamp unit is mounted inside the chassis (typically, primarily the bottom surface portion of the chassis).

However, according the backlight device having such a configuration and the display device having such a backlight device, the reflective portion is formed on a surface of the base portion of the lamp unit. Therefore, the light emitted from the lamp can be preferably reflected by the reflective portion even in the region inside the chassis where the lamp unit is mounted. Thus, according to the display device having the backlight, a high display quality can be achieved.

In a further preferred aspect of the backlight device provided in the display device disclosed here, when the lamp unit is mounted at a prescribed location inside the chassis located inside the cabinet, a surface of the reflective portion and a surface of the bottom surface portion of the chassis that is adjacent to the reflective portion are configured such that they become substantially flush with each other.

The backlight device having such a configuration is formed such that the surface of the reflective portion and the surface of the bottom surface portion of the chassis that is adjacent to the reflective portion become substantially flush with each other. Therefore, a gap that may be formed at their border (i.e., a gap region that does not reflect the light from the lamp) is suppressed to be slight or substantially absent. As a result, according to the display device provided with a backlight device having such an aspect, the light emitted from the lamp can be reflected efficiently, and the display quality can be maintained at a higher level.

In another preferred aspect of the backlight device provided in the display device disclosed, a bottom surface portion of the chassis is provided with a protruding portion that covers a portion of the base portion of the lamp unit mounted at a prescribed location inside the chassis located inside the cabinet. Here, a surface of the protruding portion is formed of a reflective member, which reflects the light from the lamp equipped in the lamp unit.

In the backlight device having such a configuration, when the lamp unit is mounted, a border area between the lamp unit and a surface of the bottom surface portion of the chassis that is adjacent to the lamp unit is covered by the protruding portion. Therefore, a gap region, which is a gap that may be formed at such a border area and which does not reflect the light from the lamp, is covered by the protruding portion. Thus, according to the display device provided with a backlight device of such a configuration, the light from the lamp can be reflected efficiently, and the display quality is maintained at a higher level.

In another preferred aspect of the display device disclosed here, the lamp unit has at least one linear lamp as the lamp. In addition, the lamp unit is configured to be inserted or removed through the lamp unit insertion opening in a lengthwise direction of the linear lamp.

In such a display device, a linear lamp can be preferably applied as the lamp. Furthermore, by mounting the lamp units of such a configuration parallel to each other inside the chassis, a display device having a configuration in which a plurality of linear lamps are stored inside the chassis such that they are arranged parallel to each other in their lengthwise direction can be achieved.

In another preferred aspect of the backlight device provided in the display device disclosed here, a circuit board for lighting a lamp is attached to a back surface side of the bottom surface portion of the chassis, and when the lamp unit is mounted at a prescribed location inside the chassis located inside the cabinet, the socket and the circuit board are configured such that they become electrically connected to each other.

In the backlight device having such a configuration and in the display device having such a backlight device, the circuit board for lighting a lamp disposed on the back surface side of the bottom surface portion of the chassis and the socket are configured such that they become electrically connected to each other. As a result, electricity can be supplied to the lamp equipped in the lamp unit smoothly, thereby suitably lighting the lamp.

More preferably, in the backlight device having the above-mentioned configuration (display device having the backlight device), the circuit board has a connector corresponding to a respective lamp provided in the lamp unit. The lamp and the circuit board are electrically connected to each other by connecting the connector to the lamp socket corresponding to the connector through a prescribed electric wire.

In the backlight device having such a configuration (and in the display device having such a backlight device), the connector in the circuit board and the socket of the lamp corresponding to the connector are connected to each other through the electric wire. This way, when removing the lamp unit from the chassis, the electrical connection between the lamp and the circuit board can be disconnected in a simple manner by removing the electric wire from the socket. When the lamp unit is inserted inside the chassis and is mounted on the chassis, the electrical connection between the lamp and the circuit board can be restored in a simple manner by connecting the electric wire to the socket. Therefore, according to the backlight device having such a configuration and the display device having such a backlight device, the circuit board for lighting a lamp attached to the back surface side of the chassis and the lamp in the lamp unit can be electrically connected to each other in a simple manner by disconnecting the electric wire from the socket and reconnecting the electric wire to the socket, thereby further facilitating removal and insertion of the lamp unit.

In a preferred aspect of the backlight device provided in the display device disclosed here, a standing portion that can constitute a portion of a side wall portion of the chassis when the lamp unit is mounted at a prescribed location inside the chassis is formed in the base portion of the lamp unit.

According to the display device provided with the backlight device having such a configuration, if a lamp unit mounting opening for mounting the lamp unit inside the chassis is formed in the side wall portion of the chassis, the lamp unit mounting opening is shielded (blocked) by the standing portion itself. Therefore, leakage of light from the lamp unit mounting opening can be prevented.

In a further preferred aspect of the backlight device provided in the display device having a configuration in which the lamp unit has the standing portion, an engaging means for maintaining the lamp unit in a mounted state inside the chassis is provided between the standing portion and the side wall portion that becomes adjacent to the standing portion when the lamp unit is mounted at a prescribed location inside the chassis.

According to the backlight device having such a configuration, when the lamp unit is mounted at the prescribed location inside the chassis, the standing portion and the side wall portion become engaged with each other by the engaging means. Therefore, the lamp unit can be prevented from easily sliding (gliding) out of the chassis due to a shock or the like, thereby securely maintaining the lamp unit in a mounted state inside the chassis.

More preferably, a handle portion for pulling out the lamp unit mounted inside the chassis to remove the lamp unit from the chassis is formed in the standing portion.

According to the backlight device having such a configuration, the lamp unit mounted inside the chassis can be pulled and removed from the chassis in a simple manner by pulling the handle portion formed in the standing portion.

A backlight device provided by the present invention has a lamp and a chassis in which the lamp is stored. Furthermore, inside the chassis, at least one lamp unit having at least one lamp and a base portion provided with a lamp socket to which the lamp is attached and to which the lamp is electrically connected is detachably mounted.

According to the backlight device according to the present invention, the lamp unit, which is detachably mounted on the chassis, can be removed from and inserted to the chassis in a simple manner. Therefore, a display device in which a lamp can be replaced at the lamp unit level in a simple manner can be achieved.

### BRIEF DESCRIPTION OF THE DRAWINGS

FIG. 1 is a cross-sectional view schematically showing a configuration of a liquid crystal display device according to an embodiment.

FIG. 2 is a cross-sectional view schematically showing main parts of a lamp unit in a mounted state inside a chassis.

FIG. 3 is a cross-sectional view along the line III-III in FIG. 2.

FIG. 4 is a cross-sectional view schematically showing main parts of a lamp unit that is being removed from the inside of a chassis to the outside of the chassis.

FIG. 5 is a perspective view schematically showing main parts of a lamp unit that is being removed from the inside of a chassis to the outside of the chassis.

FIG. 6 is a schematic view showing a connecting portion of an electric wire formed on a back surface of a base portion of a lamp unit.

FIG. 7 is a schematic view showing a connecting portion of an electric wire formed on a front surface of a standing portion of a lamp unit.

### DETAILED DESCRIPTION OF EMBODIMENTS

Several preferred embodiments of the present invention are described below with reference to figures. Any matter that is not an item specifically mentioned (configuration of a backlight, for example) in the present specification but is necessary for implementing the present invention (configuration and manufacturing method of a display panel, electric circuits related to a driving method of a lamp, and the like) can be construed as a design matter based on the conventional art by a person skilled in the art. The present invention can be implemented based on the contents disclosed in the present specification and common general technical knowledge in the art.

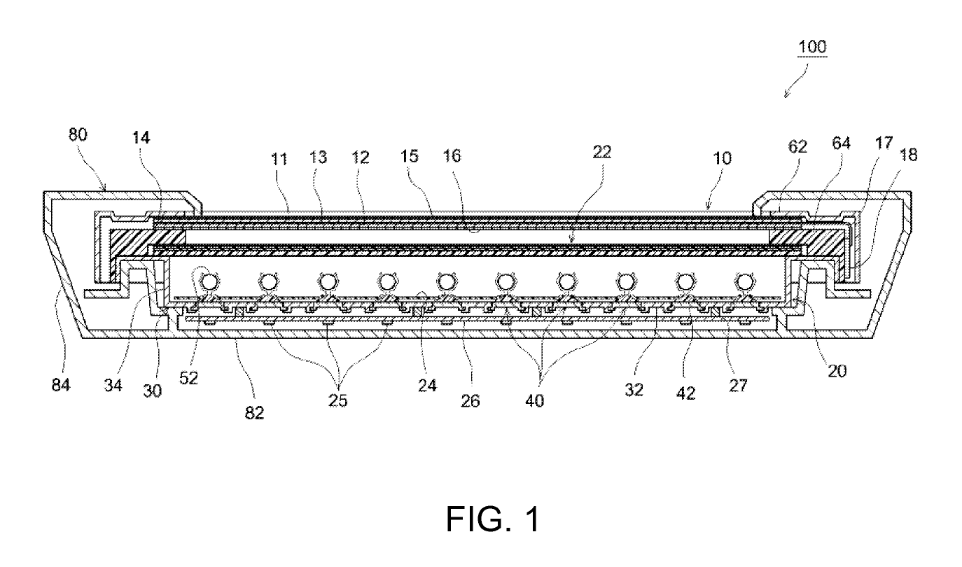

A display device according a preferred embodiment of the present invention is described below with reference to FIGS. 1 to 7 using, as an example, an active matrix type (TFT type) liquid crystal display device 100 having a liquid crystal panel 10 as a display panel. Here, in the figures below, members and regions having the same functions are given the same reference characters, and redundant description may be omitted or simplified. Furthermore, dimensional relationships (length, width, thickness, and the like) in the respective figures may not necessarily reflect the actual dimensional relationships accurately. In the description below, a “front surface”, an “upper surface”, or a “surface” represents a side of the liquid crystal display device 100 facing viewers (i.e., the side of the liquid crystal panel). A “back surface” or a “rear surface” represents a side of the liquid crystal display device 100 that is not facing the viewers (i.e., the side of the backlight device).

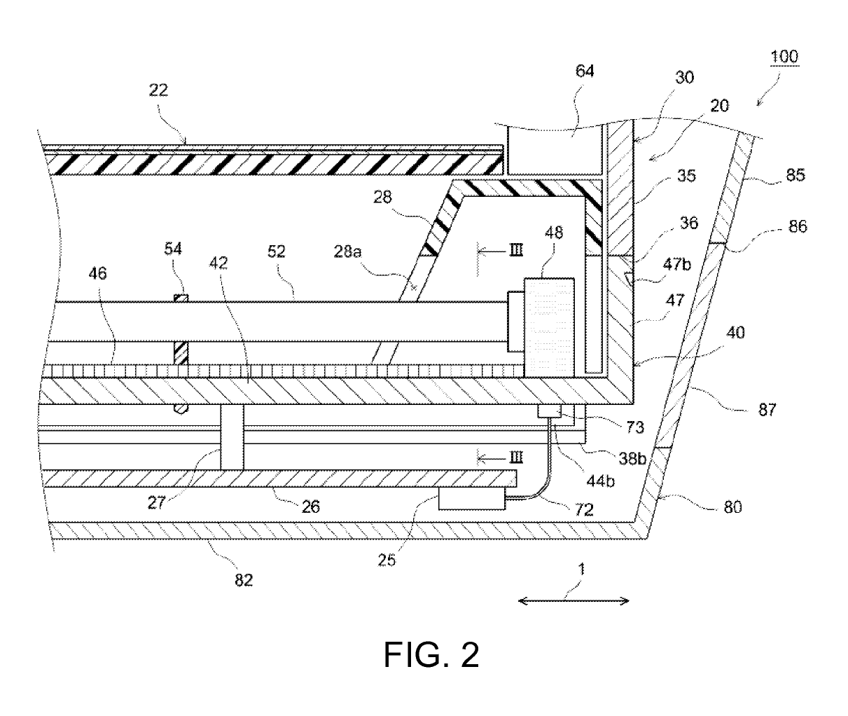

With reference to FIGS. 1 and 2, an overall configuration of the liquid crystal display device 100 is described. As shown in FIG. 1, the liquid crystal display device 100 has the liquid crystal panel 10, a backlight device 20 that is an external light source disposed on the back surface side (the lower side in FIG. 1) of the liquid crystal panel 10, and a cabinet 80 that surrounds (or stores) the liquid crystal panel 10 and the backlight device 20. The liquid crystal panel 10 and the backlight device 20 are attached to a bezel (frame body) 62 or the like to be retained integrally.

First, the liquid crystal panel 10 is described.

The liquid crystal panel 10 generally has a rectangular shape as a whole, and has a sandwich configuration that is constituted of a pair of transparent glass substrates 11 and 12 facing each other and a liquid crystal layer 13 encapsulated therebetween. Of the pair of substrates 11 and 12, the substrate on the front surface side is a color filter substrate (CF substrate) 11, and the substrate on the back surface side is an array substrate 12. Here, in peripheral portions of such glass substrates 11 and 12, a sealing member 14 for sealing the liquid crystal layer 13 is disposed. The liquid crystal layer 13 is constituted of a liquid crystal material containing liquid crystal molecules. The liquid crystal material changes the optical characteristics when the orientation of liquid crystal molecules is controlled by an applied electric field between the glass substrates 11 and 12. On surfaces of both glass substrates 11 and 12 on the sides facing each other (inner sides), alignment films (not shown in the figure) that determine the orientation direction of the liquid crystal molecules are respectively formed. On surfaces on the sides that are not facing each other (outer sides), polarizing plates 15 and 16 are respectively attached.

Although not shown in the figure, on the front surface side (the side adjacent to the liquid crystal layer 13) of the array substrate 12, pixels (specifically, subpixels), which are the smallest units for displaying an image, are arranged, and a plurality of source wires and a plurality of gate wires for driving the respective pixels (subpixels) are formed in a grid pattern. In each of the grid regions surrounded by such source wires and gate wires, a switching element (a thin film transistor (TFT), for example) and a pixel electrode are provided. A voltage corresponding to an image is supplied to the pixel electrodes through the source wires and the switching elements at prescribed timing.

Furthermore, as shown in FIG. 1, on at least one of the sides constituting the rectangular periphery of the array substrate, a plurality of flexible substrates (TCPs) 17 are attached side by side. Each of the flexible substrates 17 is equipped with a liquid crystal panel driver IC chip (driver IC chip), which is not shown in the figure, for driving the liquid crystal panel 10. At the tip of the flexible substrate 17, a connecting substrate 18 having a controller for controlling the driver IC (chip), other electronic parts, and the like is attached. The connecting substrate 18 is also referred to as a printed substrate (PCB). The flexible substrates 17 are folded toward the side of the backlight device 20, thereby disposing the connecting substrate 18 at a side surface portion (more accurately, at a side surface portion on the outer periphery side of a frame 64, which is described later) of the backlight device 20. The connecting substrate 18 may be disposed on the rear side of the backlight device 20.

On the other hand, on the CF substrate 11, a single color filter of R (red), G (green), or B (blue) is provided to face a single pixel electrode on the array substrate 12. A black matrix that demarcates the color filters of the respective colors and a common electrode (transparent electrode) uniformly formed over the color filters and the black matrix are also provided.

Here, the configuration itself of the liquid crystal panel 10, such as configurations of pixels, electrodes, driver circuits, which are described above, and the like, can be the same as that of a conventional liquid crystal panel, and does not characterize the present invention. Therefore, further description in detail is omitted.

Next, with reference to FIGS. 1 to 4, the backlight device 20 is described.

As shown in FIG. 1, the backlight device 20 is an illumination device that emits light from the rear side of the viewing direction to illuminate the liquid crystal panel 10. Simply put, the backlight device 20 is constituted of lamps 52 and a chassis 30 (also referred to as a backlight chassis or a case) that stores the lamps 52. Here, as an overall configuration of the backlight device 20, a plurality of sheet-shaped optical members 22 are laminated and disposed on the front surface side of the chassis 30 (typically, at a side wall portion 34 of the chassis 30). The optical members 22 are constituted of a diffusion plate, a diffusion sheet, a lens sheet, a luminance improving sheet, and the like, for example, which are laminated in this order from the chassis 30 side to the liquid crystal panel 10 side. However, the optical members 22 are not limited to this combination and this order. On the front surface side of the optical members 22, a substantially frame-shaped frame 64 is disposed. Along with the chassis 30, the frame 64 holds the optical members 22 by holding them from both front and back sides, and holds the liquid crystal panel 10 thereon.

On the rear side of the chassis 30, a lamp lighting circuit board (typically, an inverter circuit board equipped with inverter circuits) 26 for lighting the lamps 52 is provided. As shown in FIGS. 1 and 2, for example, the lamp lighting circuit board 26, which is supported by support elements 27, is attached to the rear side surface of a bottom surface portion (described later) 32 of the chassis 30. Here, a configuration in which the support elements 27 are not provided and in which the circuit board 26 is directly attached to the bottom surface portion 32 of the chassis 30 may be used. The circuit board 26 preferably has connectors 25 that correspond to the respective lamps 52 provided in a lamp unit 40.

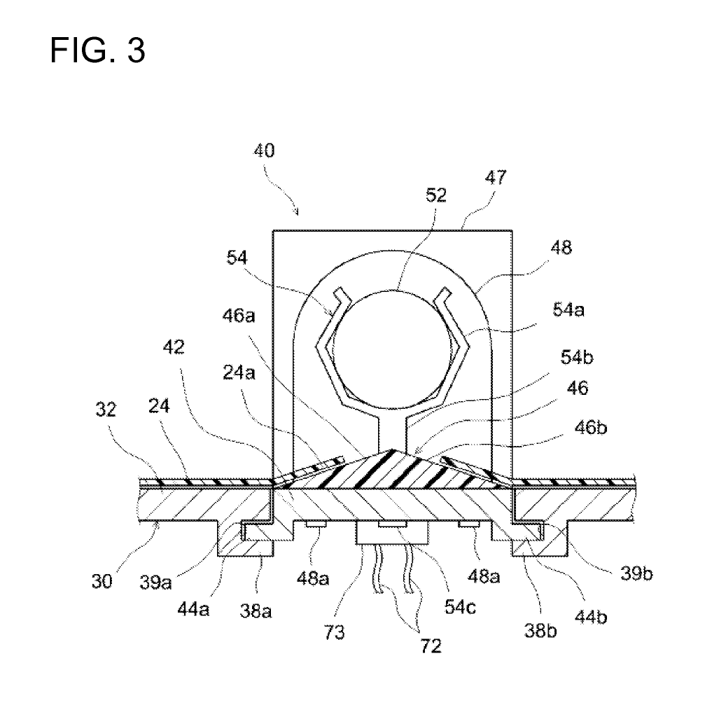

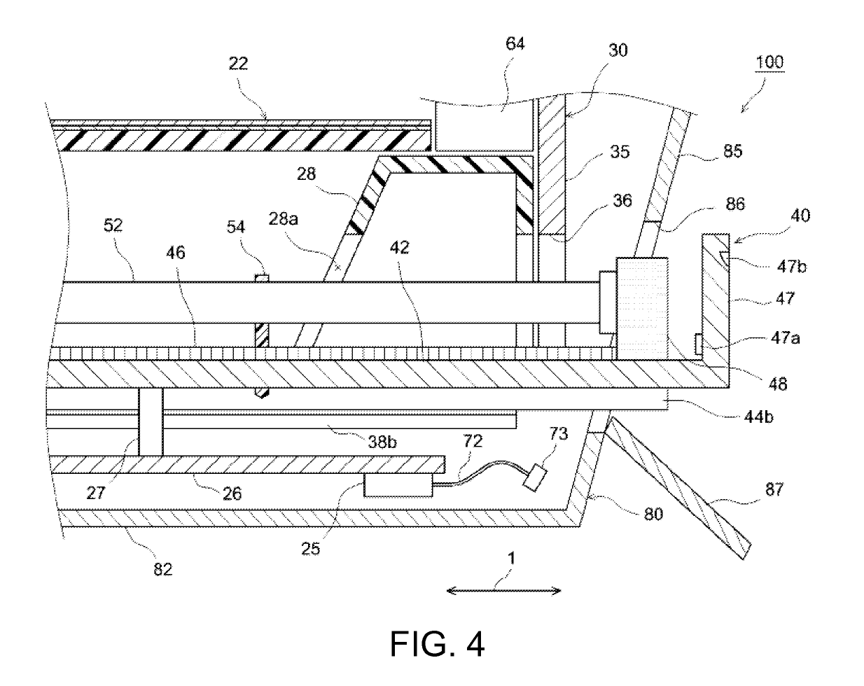

The chassis 30 is constituted of the quadrilateral (typically, rectangular) bottom surface portion 32 and a frame-shaped side wall portion 34 formed so as to surround the bottom surface portion 32, and has a shape of a box that has an opening facing the front surface side. As shown in FIG. 4, in at least one side wall 35 (hereinafter may be referred to as simply a “side wall portion 35) of a pair of side walls of such side wall portions 34 facing each other, a lamp unit mounting opening 36 for removing and inserting the lamp unit 40, which is described later, to mount the lamp unit 40 inside the chassis 30 is formed. Such a lamp unit mounting opening 36 is formed so as to face a lamp unit insertion opening 86, which is described later, in a cabinet 80 when the backlight device 20 is stored in (surrounded by) the cabinet 80. At portions of the bottom surface portion 32 of the chassis 30 that may be disposed in the proximity of the lamp unit mounting opening 36 when the lamp unit 40 is mounted inside the chassis 30, guide portions that maintain portions of a base portion 42 of the lamp unit 40 in a slidable manner are formed. As shown in FIGS. 2 to 4, a preferable example of a configuration of such guide portions is a pair of guide portions 38a and 38b facing each other that have, when viewed cross-sectionally, a U-shape extending orthogonally to the side wall portion 35 in which the lamp unit mounting opening 36 is formed. As shown in FIG. 3, such a pair of guide portions 38a and 38b has a configuration in which portions of the base portion 42 of the lamp unit 40 (i.e., in this embodiment, a pair of brim portions 44a and 44b described later) are inserted into the respective recesses (unit insertion grooves 39a and 39b) of the U-shapes viewed cross-sectionally to be retained. This way, the lamp unit 40 can be removed and inserted along the guide portions 38a and 38b in a direction orthogonal to the side wall portion 35. Therefore, a removal and insertion direction 1 (see FIGS. 2 and 4) of the lamp unit 40 through the lamp unit mounting opening 36 is a direction orthogonal to the side wall portion 35. Here, the guide portions 38a and 38b are not limited to those having the configuration shown in FIG. 3. For example, in the aspect shown in FIG. 3, the portion of the chassis bottom surface portion 32 located between one guide portion 38a and the other guide portion 38b is a notch portion. As another preferred aspect, a portion located between the guide portions 38a and 38b, which is a portion formed by integrally connecting the bottom portions of the guide portions 38a and 38b facing each other, may form a recessed portion towards the back surface side compared to the rest of the bottom surface portion 32.

In the present embodiment, the configuration in which the frame-shaped (i.e., having four walls) side wall portion 34 surrounding the quadrilateral bottom surface portion 32 is formed in the chassis 30 and in which the lamp unit mounting opening 36 through which the lamp unit 40 can be inserted is formed in the pair of side wall portions 35 of such a side wall portion 34 facing each other was described. However, the side wall portion 34 may be a side wall portion constituted of only a pair of walls facing each other (i.e., two walls). If the plane directions of such two walls are parallel to the removal and insertion direction 1 of the lamp unit 40 (i.e., if the side wall portions 35 orthogonal to the removal and insertion direction 1 are absent), the side wall portion 34 may have a configuration that does not have the lamp unit mounting opening 36.

In regions of the bottom surface portion 32 of the chassis 30 excluding the portion where the lamp unit 40 may be disposed when it is mounted at a prescribed location inside the chassis 30, a (typically, sheet-shaped) reflective member 24 for efficiently reflecting light emitted from the lamps 52 towards the front surface side (i.e., towards the liquid crystal panel 10) is disposed. Here, as shown in FIG. 3, portions of such a reflective member 24 preferably form protruding portions 24a that cover portions of the base portion 42 of the lamp unit 40 mounted inside the chassis 30 (precisely, portions of a reflective portion 46 formed on the base portion 42, which is described later). Therefore, as the protruding portions 24a, portions of the reflective member 24 preferably protrude so as to cover portions of the base portion 42 of the lamp unit 40. Because the reflective member 24 has the protruding portions 24a, border portions between the base portion 42 of the lamp unit 40 and the bottom surface portion 32 of the chassis 30 where gaps may be formed are covered by the protruding portions 24a when the lamp unit 40 is mounted. Therefore, in the bottom surface portion 32 of the chassis 30 in which the lamp unit 40 is mounted, regions that do not reflect the light emitted from the lamp 52 can be prevented from forming, and the light from the lamp 52 can be efficiently reflected towards the liquid crystal panel 10.

Furthermore, as shown in FIGS. 2 and 4, on the bottom surface portion 32 (see FIG. 1) in the chassis 30, a lamp holder 28 preferably is disposed along the side wall portion 35 in which the lamp unit mounting opening 36 is formed. The lamp holder 28 can hold an end of a linear lamp 52, which is described later, in the lengthwise direction (typically, a plurality of lamps together) inside the side wall portion 35. The upper surface (front surface) of the lamp holder 28 may be configured such that the optical members 22 and the frame 64 can be disposed thereon. In the case of such a configuration, the optical members 22 are placed over the lamp holder 28 and the chassis 30 (typically, a side wall that is parallel to the removal and insertion direction 1 of the side wall portion 34 of the chassis 30) to be securely disposed on the back surface side of the liquid crystal panel 10. Furthermore, in the lamp holder 28, an insertion opening 28a of a sufficient size for inserting the lamp unit 40 is formed at a portion through which the lamp unit 40 is inserted so that the lamp unit 40 can be removed and inserted.

Next, with reference to FIGS. 2 to 7, the lamp unit 40 is described.

The lamp unit 40 is primarily constituted of at least one lamp 52, a lamp socket 48 to which the lamp 52 is attached and to which the lamp 52 is electrically connected, and the base portion 42 to which the lamp socket 48 is attached.

As shown in FIGS. 2, 4, and 5, as the lamp 52, a linear lamp (a fluorescent tube, for example) can be preferably used. Typically, a cold cathode tube can be used as the fluorescent tube. However, in the backlight device 20 having a configuration in which the lamp can be replaced in a simple manner disclosed here, a hot cathode tube, which generally has a shorter life than the cold cathode tube and which may require more frequent lamp replacement, may be used.

When a linear lamp such as the fluorescent tube or the like is used as the lamp 52, the linear lamp 52 preferably is disposed over the base portion 42 such that the lengthwise direction of the linear lamp 52 is parallel to the removal and insertion direction 1 of the lamp unit 40 that runs through the lamp unit mounting opening 36 in the chassis 30. Furthermore, the lamp socket 48 preferably is attached to at least one of the ends of the linear lamp 52 in the lengthwise direction such that the linear lamp 52 and the lamp socket 48 are electrically connected to each other. Here, in FIGS. 2, 4, and 5, only one end of the linear lamp 52 is shown for convenience.

Furthermore, a lamp clip (lamp retainer) 54 for retaining the linear lamp 52 preferably is provided. The lamp clip 54 preferably is arranged on the base portion 42 at prescribed intervals along the lengthwise direction of the linear lamp 52. As for the shape of the lamp clip 54, any clip having a shape that has been conventionally used can be used without any particular limit. As shown in FIG. 3, for example, as such a shape, a clip having a shape provided with a lamp retainer portion 54a that retains the linear lamp 52 by surrounding the outer periphery thereof and a latch portion 54b that secures the lamp clip 54 to the base portion 42 can be mentioned. As shown in the configuration shown in FIG. 3, for example, the latch configuration of the latch portion 54b is a configuration in which a tip portion 54c of the latch portion 54b is secured to the base portion 42 by running through the base portion 42 to the rear surface side thereof. However, a configuration in which the latch portion 54b can be secured without the tip portion 54c running through the base portion 42 may be used, and the latch configuration of the lamp clip 54 is not particularly limited.

Here, the shape of the lamp 52 is not limited to the above-mentioned linear lamp, and lamps having various shapes may be used. For example, a configuration in which the lamp unit 40 has point lamps as lamps and in which the point lamps are arranged side by side at prescribed intervals on the base portion 42 may be used.

The base portion 42 preferably has a reflective portion 46 for reflecting light emitted from the lamp 52 on its surface (upper surface). As shown in FIG. 3, the shape of the reflective portion 46 preferably is a triangular columnar shape extending in the lengthwise direction of the linear lamp 52 (i.e., the removal and insertion direction 1 of the lamp unit 40), and the triangle at a cross-section of the column preferably is an isosceles triangle. Furthermore, the reflective portion 46 preferably has a configuration in which the base section of the isosceles triangle is in contact with the base portion 42; the apex section is disposed at the center of the base portion 42 in the widthwise direction (i.e., the direction orthogonal to the lengthwise direction) (typically, disposed such that the normal from the axis of the linear lamp 52 becomes the symmetry axis of the isosceles triangle); and two slanted surface portions 46a and 46b that incline gently from the apex section as the center towards the respective ends of the base portion 42 in the widthwise direction are provided. The reflective portion 46 having such a shape is preferable because the light from the lamp 52 can be efficiently reflected towards the liquid crystal panel 10.

Here, the reflective portion 46 is not limited to the above-mentioned shape, and the front surface of the reflective portion 46 may be a flat surface parallel to the front surface of the base portion 42, for example.

When the lamp unit 40 having the reflective portion 46 in the above-mentioned triangular column shape is mounted inside the chassis 30, the surface (upper surface) of the reflective portion 46 preferably becomes substantially flush with a surface of the bottom surface portion 32 of the chassis 30 adjacent to the reflective portion 46. This way, the gap that may be formed at a border section between the reflective portion 46 and the bottom surface portion 32 is suppressed to be slight or substantially absent. Therefore, a region where the light from the lamp 52 is not reflected is not formed, and the light can be reflected efficiently. Further, as shown in FIG. 3, the protruding potions 24a of the reflective member 24 are disposed so as to cover portions of the slanted surface portions 46a and 46b of the reflective portion 46. Therefore, if the surface of the reflective portion 46 and the surface of the bottom surface portion 32 are flush with each other, the reflective member 24, which covers them both, can be disposed without forming a crease, a distortion, a gap, and the like.

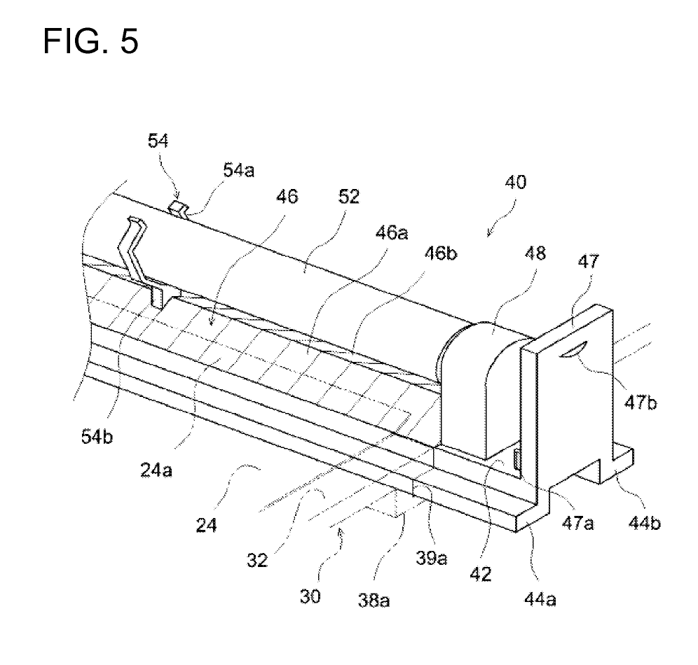

As shown in FIGS. 3 and 5, in the base portion 42 of the lamp unit 40, a pair of brim portions 44a and 44b corresponding to the guide portions 38a and 38b preferably are formed so as to protrude from both ends of the base portion 42 in the widthwise direction. Such brim portions 44a and 44b are inserted into unit insertion grooves 39a and 39b of the pair of guide portions 38a and 38b formed in the bottom surface portion 32 of the chassis 30, and can slide inside the unit insertion grooves 39a and 39b. Thus, by combining the guide portions 38a and 38b and the brim portions 44a and 44b, the lamp unit 40 is supported by the bottom surface portion 32 of the chassis 30, and can be removed and inserted with respect to the chassis 30 in a simple manner using a slide mechanism (configuration) constituted of the guide portions 38a and 38b and the brim portions 44a and 44b.

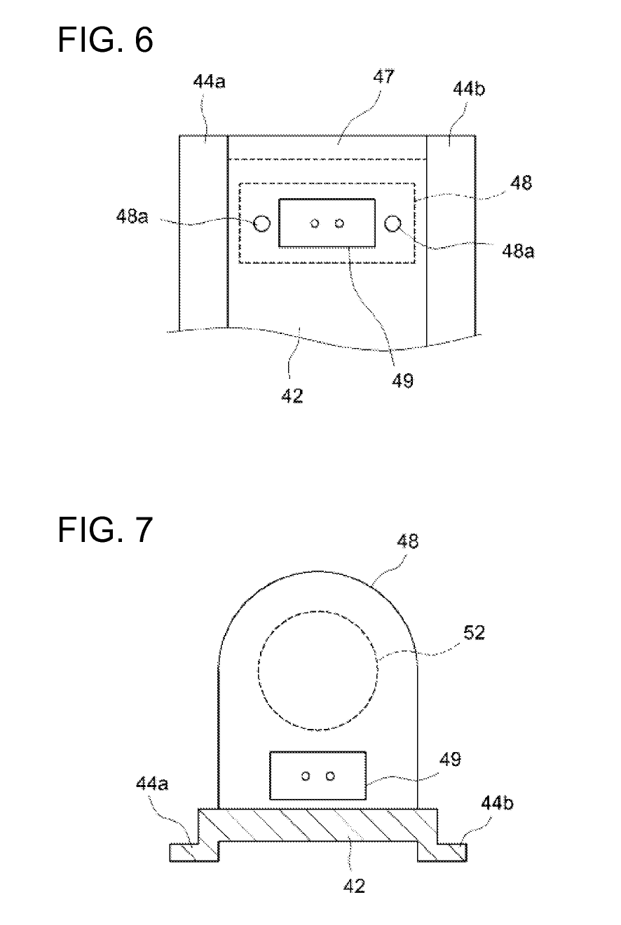

Furthermore, the lamp unit 40 preferably is configured such that when the lamp unit 40 is mounted at a prescribed location inside the chassis 30, the lamp socket 48 provided in the lamp unit 40 and the lamp lighting circuit board 26 equipped on the rear side of the chassis 30 become electrically connected to each other. The configuration of such an electrical connection is not particularly limited. For example, a configuration in which the lamp socket 48 and the circuit board 26 can be in a direct contact with each other when the lamp unit 40 is mounted may be used. Alternatively, as another preferred example, as shown in FIG. 2, a connecting portion 49 (see FIG. 6) is formed at a prescribed location in the lamp socket 48, which is attached to at least one of the ends of the linear lamp 52 in the lengthwise direction, and the connecting portion 49 and the connector 25 that is provided in the lamp lighting circuit board 26 and that corresponds to the linear lamp 52 are connected to each other through an appropriate electric wire (typically, a lead wire) 72 to electrically connect the linear lamp 52 to the circuit board 26 through the lamp socket 48. Furthermore, by providing the lamp socket 48, the linear lamp 52 can be removed from and attached to the lamp socket 48 in a simple manner when replacing the lamp, and the electrical connection between the linear lamp 52 and the circuit board 26 can be disconnected or restored in a simple manner.

Furthermore, as shown in FIG. 2, at the tip section of the electric wire 72 on the side to be connected to the lamp socket 48, a connector 73 for the socket side preferably is attached. This way, electrical connection between the lamp socket 48 (thus, the linear lamp 52) and the lamp lighting circuit board 26 can be disconnected or restored in a simpler manner by removing the electric wire 72 and the socket side connector 73 together from the connecting portion 49 and attaching them back. Here, the reference character 48a in FIG. 3 represents latch portions for securing the lamp socket 48 to the base portion 42. Such latch portions 48a are configured such that they protrude from the rear side of the base portion 42, but are not limited to such a configuration.

In the lamp socket 48, the location where the connecting portion 49 is formed is not particularly limited as long as removal and insertion of the lamp unit 40 are not obstructed. As shown in FIG. 6, a preferred example of such a formation location is a portion corresponding to the mounting location of the lamp socket 48 on the rear side surface of the base portion 42. Alternatively, as shown in FIG. 7, another preferred example of the formation location of the connecting portion 49 may be on the front surface of the lamp socket 48 (i.e., the surface that is on the opposite side from the surface to which the linear lamp 52 is attached and that faces the lamp unit mounting opening 36), and the connecting portion 49 may be formed at a lower location in the proximity of the base portion 42. By forming the connecting portion 49 at above-mentioned locations, the electric wire 72 (along with the socket side connector 73), which connects the lamp lighting circuit board 26 to the connecting portion 49, can be removed from and attached back to the connecting portion 49 in a simple manner.

Furthermore, as shown in FIGS. 2 to 5, the lamp unit 40 preferably has a standing portion 47 extending in a direction substantially perpendicular to the base portion 42 formed at least one of the ends of the base portion 42 in the lengthwise direction (i.e., the lengthwise direction of the linear lamp 52). The standing portion 47 preferably fills in the lamp unit mounting opening 36 such that it can constitute a portion of the side wall portion 35 of the chassis 30 when the lamp unit 40 is mounted at a prescribed location inside the chassis 30. When such a standing portion 47 fills in the lamp unit mounting opening 36, light emitted from the linear lamp 52 can be effectively prevented from leaking from the lamp unit mounting opening 36. As other effects, fine particles can be effectively prevented from entering the inside of the chassis 30 from the lamp unit mounting opening 36, and lowering of the mechanical strength of the overall chassis 30 that may be caused by forming the lamp unit mounting opening 36 can be prevented by constituting a portion of the side wall portion 35.

Furthermore, a prescribed engaging means preferably is provided to couple the standing portion 47 and the side wall portion 35. Using such engaging means, the lamp unit 40 can stay securely mounted inside the chassis 30. Such engaging means is not particularly limited as long as the mounted state of the lamp unit 40 can be maintained securely, and an engaging means having a conventional configuration or shape can be used. As a preferred example of such engaging means, a pair of flexible engaging claws 47a formed at both side surface portions of the standing portion 47 shown in FIG. 5 (in this figure, the other engaging claw is not shown) can be mentioned. By providing such engaging claws 47a, when the lamp unit 40 is mounted inside the chassis 30, the tips of the engaging claws 47a are bent and engaged inside the side wall portion 35 adjacent to the standing portion 47 (i.e., in the present embodiment, the periphery of the lamp unit mounting opening 36 inside the chassis 30) to be secured. This way, the lamp unit 40 can be prevented from easily sliding out of the chassis 30 when the liquid crystal display device 100 is tilted or when there is an impact to the device 100, thereby securely sustaining the mounted state. Here, the secured state can be unlocked in a simple manner by putting slightly strong pulling force on the lamp unit 40.

Here, as shown in FIG. 5, the locations where the engaging claws 47a are formed may be at both side surface portions of the standing portion 47 in the proximity of the base portion 42. However, it is not limited to such locations, and the engaging claws 47a may be formed at an upper end surface portion of the standing portion 47, for example. The portions of the side wall portion 35 that become engaged to the engaging claws 47a may be configured to be engaging holes (or recess portions) that engage with engaging claws 47a.

Here, if the lamp unit 40 is attached and removed (removed and inserted) manually, a recess portion (hollow) or a protruding portion (i.e., a handle portion) having a prescribed shape that can function as a handle preferably is formed in the standing portion 47. For example, in the example shown in FIG. 5, a handle portion 47b having a hollow of a prescribed shape (substantially forming a crescent moon shape in the figure) is formed in the front surface portion of the standing portion 47 (outer surface of the chassis 30 constituting a portion of the side wall portion 35 when the lamp unit 40 is mounted inside the chassis 30). By using such a handle portion, the lamp unit 40 mounted inside the chassis 30 can be pulled and removed from the chassis 30 in a simple manner. The shape and the formation location of the handle portion is not limited to the example shown in FIG. 5 as long as they are a shape and a location that can pull out the lamp unit 40 in a simple manner and that do not interfere with other members when removing and inserting the lamp unit 40.

Because the lamp unit 40 having the linear lamp 52 can be removed from and inserted into the chassis 30 through the lamp unit mounting opening 36 along the lengthwise direction of the linear lamp 52 as described above, the plurality of lamp units 40 having the above-mentioned configuration that are arranged parallel to each other can be mounted inside the chassis 30. By using such a configuration, the backlight device 20 that is stored inside the chassis 30 and that has the plurality of linear lamps 52 arranged parallel to each other along the lengthwise direction (i.e., the removal and insertion direction 1 of the lamp unit 40) can be achieved in a simple manner. The number of the linear lamps 52 provided in a single lamp unit 40 is not particularly limited, and the lamp unit 40 having a single or a plurality of linear lamps 52 can be used.

As shown in FIG. 1, the liquid crystal panel 10 and the backlight device 20 are stored such that they are surrounded by a cabinet 80. Such a cabinet 80 has a quadrilateral side wall portion 84 in a frame shape so as to surround the chassis 30. As shown in FIG. 1, the cabinet 80 may have a configuration having a bottom surface portion 82 on the back surface side of the backlight device 20. Further, in at least one side wall 85 (hereinafter, may be simply referred to as a “side wall portion 85”) of a pair of side walls of the quadrilateral side wall portion 84 facing each other, a lamp unit insertion opening 86 preferably is formed. Here, the side wall portion 85 faces the side wall portion 35 of the chassis 30 of the backlight device 20 stored in the cabinet 80. The lamp unit insertion opening 86 is formed at a location facing the lamp unit mounting opening 36 formed in the side wall portion 35 (typically, a plurality of lamp unit mounting openings 36 are arranged along the widthwise direction (i.e., the direction perpendicular to the removal and insertion direction 1 of the planar directions of the side wall portion 35) of the side wall portion 35). The size of the lamp unit insertion opening 86 is not particularly limited, and a side of the lamp unit insertion opening 86 has a length corresponding to the length of the widthwise direction of the side wall portion 35, for example. The cabinet 80 preferably has a cover body 87 that fills in the lamp unit insertion opening 86 and that can constitute a portion of the side wall portion 85 when the lamp unit insertion opening 86 is closed. Here, the configuration of how the cover body 87 is attached to the main body of the cabinet is not particularly limited. As shown in the figure, it may be configured such that it is simply inserted into the lamp unit insertion opening 86. Alternatively, it may be secured to the main body of the cabinet (the side wall portion 85, for example) such that it can be opened and closed using hinges or the like, for example. Because the cabinet 80 has the lamp unit insertion opening 86 (and preferably the cover body 87) as described above, the lamp unit 40 can be removed or inserted through the lamp unit insertion opening 86 by opening the cover body 86, and there is no need to remove the backlight device 20 by disassembling the cabinet 80. Thus, the liquid crystal display device 100 in which lamp replacement can be performed in a very simple manner can be achieved.

Next, with reference to FIGS. 2, 4, and 5, a typical example of a lamp replacement method in the liquid crystal display device 100 disclosed here is described.

As shown in FIG. 2, in the liquid crystal display device 100, the lamp unit 40 is mounted at a prescribed location inside the chassis 30 located inside the cabinet 80. Here, the pair of brim portions 44a and 44b, which are formed so as to protrude from the base portion 42 of the lamp unit 40 in its widthwise direction, are respectively inserted into the pair of guide portions 38a and 38b (precisely, the unit insertion grooves 39a and 39b) formed in the bottom surface portion 32 of the chassis 30 adjacent to the lamp unit mounting opening 36. This way, the lamp unit 40 is supported by the bottom surface portion 32 of the chassis 30, thereby achieving the mounting of the lamp unit 40.

Next, as shown in FIGS. 2 and 4, the cover body 87, which constitutes a portion of the side wall portion 85 of the cabinet 80, is opened to open the lamp unit insertion opening 86. Next, the electric wire 72 that has one end connected the connecting portion 49 (see FIG. 6) formed on the rear side of the base portion 42 at a location where the lamp socket 48 is mounted, for example, and that has the other end connected to the connector 25 of the lamp lighting circuit board 26 equipped on the rear side of the chassis 30 is disconnected along with the socket side connector 73 from the connecting portion 49 to disconnect electrical connection (a configuration in which the electric wire 72 is automatically disconnected may be used. In that case, the electric wire 72 is disconnected by turning on a disconnect switch.).

Next, as shown in FIGS. 4 and 5, the lamp unit 40 that is electrically disconnected from the circuit board 26 is pulled (using the handle portion 47b formed at a prescribed location in the standing portion 47, for example) towards the lamp unit mounting opening 36 to unlock engagement of the pair of engaging claws 47a attached to both side surface portions of the standing portion 47 and the side wall portion 35 (peripheral portion of the lamp unit mounting opening 36) that was engaged with the engaging claws 47a. Then, the lamp unit 40 is slid along the lengthwise direction (i.e., the removal and insertion direction 1 of the lamp unit 40) of the linear lamp 52 of the lamp unit 40, and is removed from the chassis 30 through the lamp unit mounting opening 36. Further, the lamp unit 40 is removed from the cabinet 80 through the lamp unit insertion opening 86. Here, the pair of brim portions 44a and 44b moves inside the unit insertion grooves 39a and 39b while respectively staying inside the unit insertion grooves 39a and 39b in the guide portions 38a and 38b formed along the lengthwise direction, thereby enabling the lamp unit 40 to slide in the lengthwise direction. This way, the linear lamp 52 inside the cabinet 80 can be removed from the cabinet 80 along with the lamp unit 40 in a simple manner.

In the lamp unit 40 removed from the inside of the cabinet 80 to the outside of the cabinet 80, the linear lamp 52 is removed from the lamp clip 54 and the lamp socket 48 of the lamp unit 40. A new linear lamp 52 is set to the lamp retainer portion 54a of the lamp clip 54, and the lamp 52 is mounted to the lamp socket 48. Here, replacement of the linear lamp 52 can be performed in a simple manner by removing the linear lamp 52 from the lamp socket 48 and reattaching it and by removing the linear lamp 52 from the lamp clip 54 and reattaching it.

The lamp unit 40 having the newly replaced linear lamp 52 is mounted to the chassis 30 inside the cabinet 80. Here, the lamp unit 40 is pushed into the cabinet 80 through the lamp unit insertion opening 86 such that the brim portions 44a and 44b of the lamp unit 40 are inserted into the unit insertion grooves 39a and 39b in the guide portions 38a and 38b of the chassis 30. Next, the lamp unit 40 is pushed into the chassis 30 through the lamp unit mounting opening 36, and is slid in the opposite direction from when the lamp unit 40 was removed (i.e., the inserting direction into the chassis 30). When inserting the lamp unit 40 inside the chassis 30, the lamp unit 40 is slid such that the protruding portions 24a formed of portions of the reflective member 24 disposed on the bottom surface portion 32 are disposed on the front surface side of the slanted surface portions 46a and 46b of the reflective portion 46 of the lamp unit 40 (i.e., such that the rear side surface of the protruding portions 24a and the slanted surface portions 46a and 46b of the reflective portion 46 are in contact with each other). When the standing portion 47 of the lamp unit 40 reaches the side wall portion 35, sliding (insertion) is stopped. At this time, the pair of engaging claws 47a of the standing portion 47 becomes engaged again with the side wall portion 35 (peripheral portion of the lamp unit mounting opening 36). This way, the lamp unit 40 is mounted again at the prescribed location inside the chassis 30 located inside the cabinet 80.

Lastly, with the socket side connector 73, the electric wire 72 that has been disconnected is reconnected to the connecting portion 49 of the lamp unit 40. This way, the electrical connection between the lamp lighting circuit board 26 and the linear lamp 52 is restored back. Then, the cover body 87 of the cabinet 80 is closed to fill in the lamp unit insertion opening 86.

Lamp replacement can be performed in a simple manner at the lamp unit 40 level as described above.

The present invention was described above using preferred embodiments. However, the present invention is not limited to such descriptions, and without doubt, various modifications are possible. For example, depending on the shape and the driving method for lighting of the linear lamp 52, a configuration in which the lamp unit mounting openings 36 are provided in both of the pair of side wall portions 35 facing each other such that the lamp unit 40 can be removed and inserted from both sides may be used. Alternatively, a configuration in which the lamp unit mounting opening 36 is formed in only one of the side wall portions 35 such that the lamp unit 40 is removed and inserted from only one side may be used.

Furthermore, unlike above-mentioned descriptions, a configuration in which a side wall portion having a planar direction that is perpendicular to the removal and insertion direction of the lamp unit 40 in the side wall portion 34 of the chassis 30 (i.e., the side wall portion 35) is not formed and in which the lamp unit mounting opening 36 is not provided may be used. As the lamp unit 40 used in the case of such a configuration, a lamp unit having a configuration in which the standing portion 47 that fills in the lamp unit mounting opening 36 and that can constitute a portion of the side wall portion 35 when mounted inside the chassis 30 is not formed may be used.

Furthermore, in the embodiments above, a liquid crystal display device was described as a typical example of a display device. However, the present invention can be applied to various types of display devices having a similar backlight device and a display panel that is illuminated by the backlight device.

### INDUSTRIAL APPLICABILITY

According to the present invention, a display device having a lamp unit that can be removed from and inserted into a cabinet through a lamp unit insertion opening formed in the cabinet is provided. This display device allows the lamp unit having a lamp that needs to be replaced due to an end of service life or the like to be removed from the inside of the cabinet to the outside of the cabinet through the lamp unit insertion opening in a simple manner, and allows the lamp unit to be inserted and mounted from the outside of the cabinet to the inside of the cabinet. Thus, lamp replacement can be performed at the lamp unit level in a simple manner without disassembling the display device.

### DESCRIPTION OF REFERENCE CHARACTERS

10 liquid crystal panel
11 color filter substrate (CF substrate)
12 array substrate
13 liquid crystal layer
14 sealing material
15, 16 polarizing plates
17 flexible substrate
18 connecting substrate
20 backlight device
22 optical member
24 reflective member
24a protruding portion
25 connector
26 lamp lighting circuit board
28 lamp holder
28a insertion opening
30 chassis
32 bottom surface portion
34 side wall portion
36 lamp unit mounting opening
38a, 38b guide portions
39a, 39b unit insertion grooves
40 lamp unit
42 base portion
44a, 44b brim portions
46 reflective portion
46a, 46b slanted surface portions
47 standing portion
47a engaging claw
47b handle portion
48 lamp socket
48a latch portion
49 connecting portion
52 lamp
54 lamp clip
54a lamp retainer portion
54b latch portion
54c tip portion
62 bezel
64 frame
72 electric wire
73 socket side connector
80 cabinet
84 quadrilateral side wall portion
85 side wall portion
86 lamp unit insertion opening
87 cover body
100 liquid crystal display device

1. A display device, comprising:
a backlight device having a lamp and a chassis in which said lamp is stored;
a display panel illuminated by said backlight device; and
a cabinet surrounding said backlight device and said display panel,
wherein inside said chassis, at least one lamp unit having at least one lamp and a base portion provided with a lamp socket to which said lamp is attached and to which said lamp is electrically connected is detachably mounted, and
wherein in a portion of a wall of said cabinet, a lamp unit insertion opening through which said lamp unit can be inserted or removed is formed so that said lamp unit is removed from an inside of said cabinet to an outside of the cabinet and that the lamp unit is inserted from the outside of the cabinet to the inside of the cabinet through said lamp unit insertion opening.

2. The display device according to claim 1, wherein said cabinet has a frame-shaped quadrilateral side wall portion formed so as to surround said chassis,
wherein said lamp unit insertion opening is formed in at least one side wall of a pair of side walls of said quadrilateral side wall portion facing each other, and
wherein at a bottom surface portion of said chassis that is adjacent to said lamp unit insertion opening, a guide portion that retains a portion of the base portion of said lamp unit inserted from said lamp unit insertion opening in a slidable manner is formed.

3. The display device according to claim 1, wherein a reflective portion for reflecting light emitted from a lamp provided in said lamp unit is formed on at least a portion of a surface of the base portion of said lamp unit.

4. The display device according to claim 3, wherein a surface of said reflective portion and a surface of the bottom surface portion of said chassis that is adjacent to said reflective portion become substantially flush with each other when said lamp unit is mounted at a prescribed location inside said chassis located inside said cabinet.

5. The display device according to claim 1, further comprising, at a bottom surface portion of said chassis, a protruding portion that covers a portion of the base portion of said lamp unit mounted at a prescribed location inside said chassis located inside said cabinet,
wherein a surface of said protruding portion is formed of a reflective member that reflects light from a lamp provided in said lamp unit.

6. The display device according to claim 1, wherein said lamp unit has at least one linear lamp as said lamp, and said lamp unit is inserted or removed through said lamp unit insertion opening in a lengthwise direction of said linear lamp.

7. The display device according to claim 1, wherein a circuit board for lighting a lamp is attached to a rear surface side of the bottom surface portion of said chassis, and
wherein said socket and said circuit board become electrically connected to each other when said lamp unit is mounted at a prescribed location inside said chassis located inside said cabinet.

8. The display device according to claim 7, wherein said circuit board is provided with a connector corresponding to a respective lamp equipped in said lamp unit, and
wherein said connector and the lamp socket corresponding to said connector are connected to each other through a prescribed electric wire to electrically connect said lamp to said circuit board.

9. The display device according to claim 1, wherein in the base portion of said lamp unit, a standing portion that can constitute a portion of a side wall portion of said chassis when said lamp unit is mounted at a prescribed location inside said chassis is formed.

10. The display device according to claim 9, wherein an engaging means for maintaining said lamp unit in a mounted state inside said chassis is provided between said standing portion and said side wall portion that becomes adjacent to said standing portion when said lamp unit is mounted at a prescribed location inside said chassis.

11. The display device according to claim 9, wherein a handle portion for pulling said lamp unit mounted inside said chassis and removing it from said chassis is formed in said standing portion.

12. A backlight device used for a display device, comprising a lamp and a chassis in which said lamp is stored,
wherein at least one lamp unit having at least one lamp and a base portion provided with a lamp socket to which said lamp is attached and to which said lamp is electrically connected is detachably mounted inside said chassis.
